(19) United States
(12) Patent Application Publication
(10) Pub. No.: US 2003/0215706 A1
(43) Pub. Date: Nov. 20, 2003

(54) Current collection through the ends of a spirally wound electrochemical cell by the use of a wound wire

(75) Inventors: Peter A. Alunans, Baltimore, MD (US); John A. Willson, Cockeysville, MD (US)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/146,909

(22) Filed: May 17, 2002

(51) Int. Cl. H01M 2/26

(52) U.S. Cl. 429/161

(57) ABSTRACT

An electrochemical cell having an improved current connector. The electrochemical cell includes a plurality of positive and negative plates and a separator interposed therebetween; a first current connector for electrically connecting adjacent ones of said positive plates; and a second current connector for electrically connecting adjacent ones of said negative plates. Each of the first and second connectors includes a spring member defined by adjacent turns respectively having spaces therebetween, wherein the positive plates are partially disposed in the spaces of the first connector and the negative plates are partially disposed in the spaces of the second connector. The spring member may be a coiled member of a serpentine member. Alternatively, the current connector is a V-shaped member having the slots formed therein by etching or the like.

### BACKGROUND OF THE INVENTION

1. Field of the Invention

The present invention relates to an electrochemical cell, and more particularly, to an electrochemical cell that includes a connecting structure for interconnecting adjacent electrode plates associated with the cell.

2. Related Art

The related art includes electrochemical cells having electrode stacks with current collection tabs extending therefrom for facilitating electrical connection with the respective terminals of the cell. There are a number of problems with this tab design.

First, the tabs are attached to the electrode stacks by welding the tabs to electrode sheets as they are unwound from a roll. This welding step slows down the process of forming the cells, reducing the efficiency of the manufacturing process.

Additionally, the current collection tabs must be sufficiently long to enable them to be electrically connected to the terminals. Once the jellyroll cell has been formed, there are many tabs protruding from opposite ends of the cell making the cell awkward to handle. Further, it is both time consuming and difficult to electrically attach the many tabs, directly or indirectly, to the respective terminals. If some of the tabs are inadvertently not connected to the terminals, the current capacity of the electrochemical cell is decreased.

### SUMMARY OF THE INVENTION

According to a first aspect of the invention, an electrochemical cell is provided. The electrochemical cell comprises: a plurality of positive and negative plates and a separator interposed therebetween; a first current connector for electrically connecting adjacent ones of said positive plates; a second current connector for electrically connecting adjacent ones of said negative plates, wherein each of said first and second connectors comprises a spring member defined by adjacent turns respectively having spaces therebetween, wherein said positive plates are partially disposed in the spaces of the first connector and said negative plates are partially disposed in the spaces of the second connector. The spring member may be a coiled member, a serpentine member or the like.

According to a second aspect of the invention, the electrochemical cell comprises: a plurality of positive and negative plates and a separator interposed therebetween; a first current connector for electrically connecting adjacent ones of said positive plates; a second current connector for electrically connecting adjacent ones of said negative plates, wherein each of said first and second connectors comprises an elongated, substantially V-shaped, member defined by two slanting plates joined by an apex portion having a plurality of transverse slots therein, wherein said positive plates are received in the slots of the first connector and said negative plates are received in the slots of the second connector.

According to yet another aspect, the invention is directed to a current connector that is a spring member formed as a coiled member or a serpentine member defining slots in which the positive or negative plates are received.

According to a further aspect of the invention, the current connector is an elongated, substantially V-shaped, member defined by two slanting plates joined by an apex portion having a plurality of transverse slots therein, wherein said plates are received in the slots.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1A is a perspective view of an electrochemical cell according to a first embodiment of the invention and FIG. 1B is an exploded view of a portion of FIG. 1A;

FIG. 2 is a perspective view of a jelly-roll cell structure;

FIG. 3A is a perspective view of an electrochemical cell according to a second embodiment of the invention, FIG. 3B is an exploded view of a portion of FIG. 3A, FIG. 3C is a side view of the current connector of this embodiment and FIG. 3D is an end view of the current connector; and

FIG. 4A is a perspective view of an electrochemical cell according to a third embodiment of the invention, FIG. 4B is an exploded view of a portion of FIG. 4A, FIG. 4C is a side view of the current connector of this embodiment and FIG. 4D is an end view of the current connector.

### DETAILED DESCRIPTION OF THE INVENTION

The invention will now be taught using various exemplary embodiments. Although the embodiments are described in detail, it will be appreciated that the invention is not limited to just these embodiments, but has a scope that is significantly broader. The appended claims should be consulted to determine the true scope of the invention.

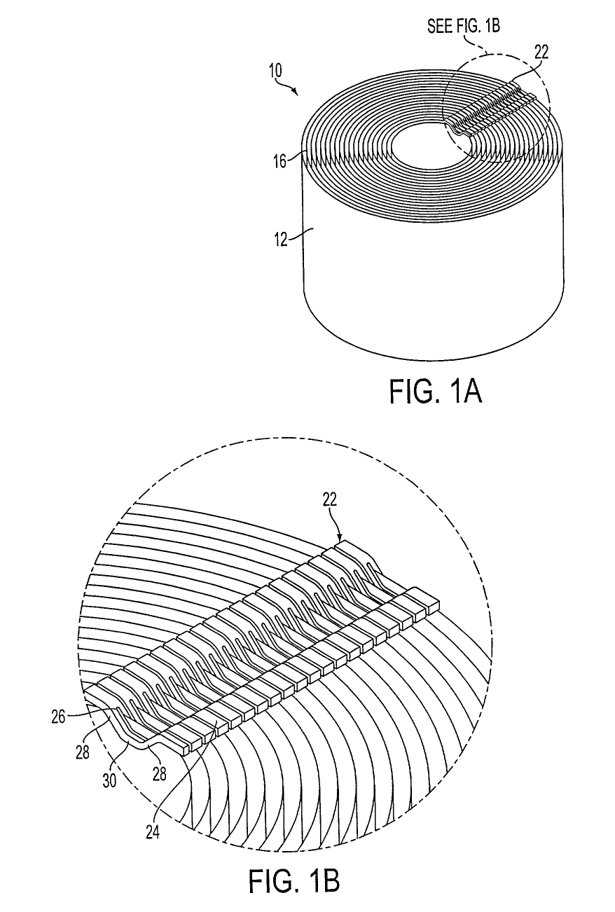

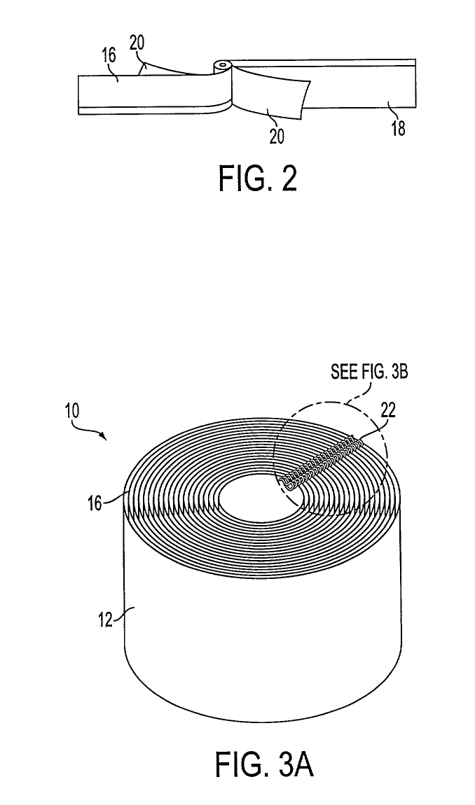

A preferred embodiment of the invention is illustrated in FIGS. 1A and B and FIG. 2. According to a first aspect of the invention, the electrochemical cell 10 includes an electrode stack 12 placed in a case (not shown). The electrode stack 12 is formed in the conventional manner and includes a positive plate 16 and a negative plate 18 with an insulating separator 20 therebetween. According to the preferred embodiment and as illustrated in FIG. 2, the cell stack 12 is formed by placing the separator 20 between a continuous strip of each plate to form an assembly and, thereafter, rolling the assembly into a roll, in a conventional manner. Of course, the spirally wound assembly can, alternatively, be formed into cylindrical, oval or rectangular shapes to accommodate any ultimate shape that may be desired.

On the other hand, the electrode cell 10 may be formed by positioning, in a conventional manner, stacking plates 16, 18 and separators 20 alternately of one another in the desired shape. Such plates and separators may be stacked and pressed to the desired pressure and placed in a case resulting in the conventional parallel plate construction.

The positive and negative plates 16, 18 are preferably configured such that the positive plate 16 extends from one end of the electrode stack and the negative plate 18 extends from the opposite end of the electrode stack. Positive and negative current connectors 22 are respectively affixed to the ends of the positive and negative plates 16 and 18. For simplicity, the drawings illustrate the current connectors attached to the positive plates 16.

According to the first embodiment, each of the current connectors 22 is a V-shaped conductive member 24 having a series of slots or gaps 26 formed therein, as shown in FIG. 1B. More specifically, each of the connectors 22 is an elongated, substantially V or U-shaped, member 24 defined by two slanting plates 28 joined by an apex portion 30 having the slots 26 therein,

The current connectors are conductive and can be made of copper, aluminum, nickel or the like. The slots can be formed in any conventional manner, including, but not limited to, etching.

Referring to FIGS. 1A and B, the connectors 22 are positioned at the opposite ends of the electrochemical cell 10 with the successive turns of the positive and negative electrode plates 16, 18 received in respective slots 26 of the current connector 22. Thereafter, according to the preferred embodiment, the electrode plates 16 and 18 are preferably attached to the current connectors 22 in a conventional manner such by resistance welding, laser welding, plasma spray, or any other mechanical connection. A plurality of current connectors 22 may be provided at each end for attaching to the positive and negative electrode plates. For example, it may be preferable to provide four current connectors 18 at each end and 90° apart. However, the invention is not limited in this respect and is intended to cover any number of current connectors.

The current connectors are electrically connected to the positive and negative battery terminals in a conventional manner, such as by providing a leads that extend from the respective current connectors to the positive and negative terminals, as disclosed in U.S. Pat. No. 4,332,867, which is incorporated herein by reference. Alternatively, conductive ring-like members, electrically connected to the respective terminals, may be provided over the current connectors to interconnect the respective current connectors to the terminals.

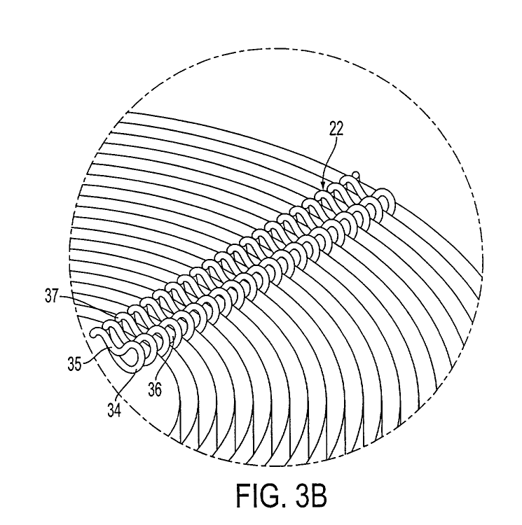

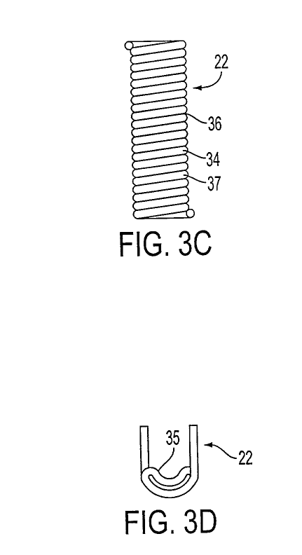

FIGS. 3A-D illustrate a second embodiment of the invention. In this embodiment, the current connectors 22 resemble a coiled spring 34, one side 35 of which in indented inwardly to form a kidney shape in cross-section, as shown in FIG. 3D. The coiled spring 34 includes gaps 36 defined between adjacent coils 37 of the spring. As with the first embodiment, the ends of the respective positive and negative electrode plates 16, 18 are received in the gaps 36 between the adjacent coils of the current connectors 22 and the plates 16, 18 are, thereafter preferably connected to the connectors, as discussed above. The current connector of this embodiment is formed of a conductive metal such as those discussed above in regard to the first embodiment.

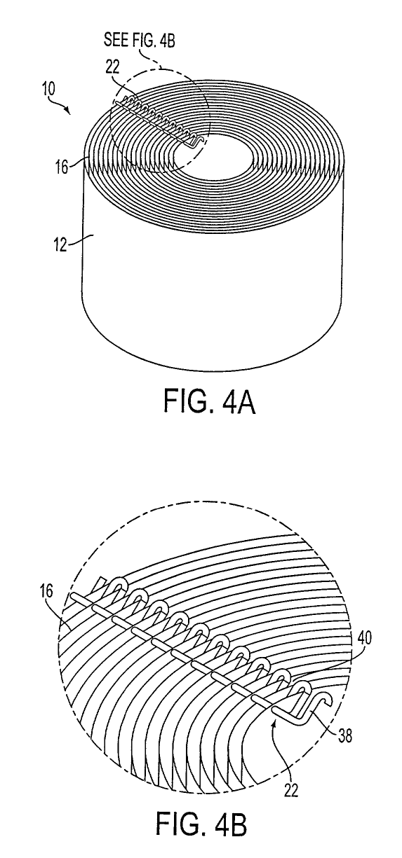

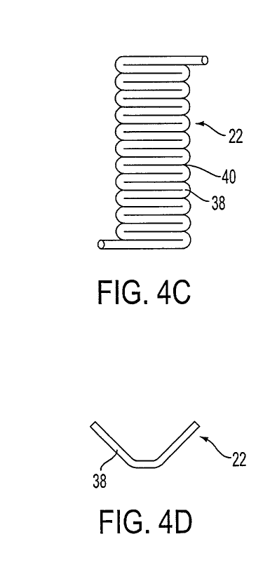

A third embodiment of the invention is illustrated in FIGS. 4A-D. In this embodiment, the current connectors 22 are formed by bending a an elongated member 38 in a serpentine manner with a V or U-shape cross-section (FIG. 4D) such that slots 40 are defined between adjacent bends. As with the embodiments discussed above, the current connectors 22 are positioned over the positive and negative plates 16, 18 with the turns of the plates being received in the slots 38, as shown in FIG. 4. Thereafter, the plates are preferably connected to the connectors as discussed above. The respective connectors are then electrically connected to the positive and negative terminals in a conventional manner, as discussed above.

The advantage of the invention is that the conventional tabs may be eliminated, if desired. As a result, the labor and cost associated with forming the electrochemical cell is reduced. That is, it is much easier to manufacture the electrode plates without the tabs. In addition, it is much less time consuming to assemble the electrode plates into an electrochemical cell due to the elimination of the tabs. For example, in the jelly-roll design discussed above, the electrode plate assembly can be easily rolled without having to worry about the tabs. This saves both time and money during manufacturing.

In addition, the connectors can easily be secured to the positive and negative plates 16 and 18 by resistance welding, laser welding, plasma spray, or any other mechanical connection or the like.

The foregoing description is merely exemplary and is not to be construed in a limiting sense. Modifications will be readily apparent to those of ordinary skill in the art, and are considered to be within the scope of the invention, which is to be limited only by the following claims. For example, although reference is made to the current connectors being V-shaped, it is understood that the could also be U-shaped without departing from the spirit or scope of the invention. Indeed, reference to V-shaped is intended to include a U-shape arrangement.

What is claimed is:

1. An electrochemical cell, comprising:
a plurality of positive and negative plates and a separator interposed therebetween;
a first current connector for electrically connecting adjacent ones of said positive plates;
a second current connector for electrically connecting adjacent ones of said negative plates,
wherein each of said first and second connectors comprises a spring member defined by adjacent turns respectively having spaces therebetween, wherein said positive plates are partially disposed in the spaces of the first connector and said negative plates are partially disposed in the spaces of the second connector.

2. The electrochemical cell of claim 1, wherein said spring member is a helical spring.

3. The electrochemical cell of claim 1, wherein said spring member includes a elongated metal member bent in an accordion manner.

4. The electrochemical cell of claim 3, wherein said spring member has a V-shape in cross-section.

5. The electrochemical cell of claim 1, wherein said first and second connectors are respectively welded to said positive and negative plates.

6. The electrochemical cell of claim 1, further comprising additional ones of said first and second current connectors.

7. The electrochemical cell of claim 6, where said first current connectors are positioned 90° with respect to each other and said second current connectors are positioned 90° with respect to each other.

8. An electrochemical cell, comprising:
a plurality of positive and negative plates and a separator interposed therebetween;
a first current connector for electrically connecting adjacent ones of said positive plates;
a second current connector for electrically connecting adjacent ones of said negative plates,
wherein each of said first and second connectors comprises an elongated, substantially V-shaped, member defined by two slanting plates joined by an apex portion having a plurality of transverse slots therein, wherein said positive plates are received in the slots of the first connector and said negative plates are received in the slots of the second connector.

9. The electrochemical cell of claim 8, further comprising additional ones of said first and second current connectors.

10. The electrochemical cell of claim 9, where said first current connectors are positioned 90° with respect to each other and said second current connectors are positioned 90° with respect to each other.

11. An connector member for interconnecting electrode plates of a battery, comprising:
a spring member defined by adjacent turns respectively having spaces therebetween, wherein said electrode plates are partially receivable in the spaces.

12. The connector member of claim 11, wherein said spring member is a helical spring.

13. The electrochemical cell of claim 12, wherein said spring member includes a elongated metal member bent in an accordion manner to define an accordion member.

14. The electrochemical cell of claim 13, wherein said spring member has a V-shape in cross-section.

15. An connector member for interconnecting electrode plates of a battery, comprising:
an elongated, substantially V-shaped, member defined by two slanting plates joined by an apex portion having a plurality of transverse slots therein, wherein said plates are received in the slots.
